(19) United States
(12) Patent Application Publication
(10) Pub. No.: US 2004/0204596 A1
(43) Pub. Date: Oct. 14, 2004

(54) Method for the preparation of unsaturated hydroxy fatty acids and their esters, their use in pharmaceutical and/or cosmetic preparations

(75) Inventors: Pierre Potier, Paris (FR); Francoise Picot, Chevreuse (FR); Jean-Louis Brayer, Nanteuil le Haudouin (FR)

Correspondence Address: IP DEPARTMENT OF PIPER RUDNICK LLP, ONE LIBERTY PLACE, SUITE 4900, 1650 MARKET ST, PHILADELPHIA, PA, 19103, US

(73) Assignee: Pierre Potier, Paris (FR)

(21) Appl. No.: 10/799,532

(22) Filed: Mar. 12, 2004

Related U.S. Application Data
(63) Continuation of application No. PCT/FR02/03094, filed on Sep. 11, 2002.

(30) Foreign Application Priority Data
Sep. 11, 2001 (FR) 01/11815

(51) Int. Cl. C07F 7/02; C11B 3/00

(52) U.S. Cl. 554/77; 554/124

(57) ABSTRACT

A method of preparing unsaturated hydroxy fatty acids and esters thereof corresponding to general formula (Id):

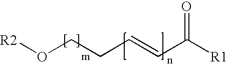

wherein n=1 to 4, m=2 to 16, R₁═OH, Cl, Br, OR₃ in which R₃ is a straight or branched alkyl, alkenyl or alkynyl radical of 1 to 16 carbons or glycerol esters, optionally substituted by one or more atoms selected from the group consisting of carbon, nitrogen, sulfur and halogens, R₂═H, SiR′₁R′₂R′₃ in which R′₁, R′₂ and R′₃ can be identical or different from each other and are a straight or branched alkyl, alkenyl or alkynyl radical of 1 to 16 carbons or glycerol esters, optionally substituted by one or more atoms selected from the group consisting of carbon, nitrogen, sulfur and halogens, or R₂═C—Ar₃ with Ar representing an aryl radical optionally substituted by one or more atoms selected from the group consisting of carbon, nitrogen, sulfur and halogens, or R₂=the tetrahydropyranyl of formula:

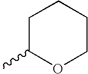

is disclosed.

### RELATED APPLICATION

This is a continuation of International Application No. PCT/FR02/03094, with an international filing date of Sep. 11, 2002 (WO 03/022787, published Mar. 20, 2003), which is based on French Patent Application No. 01/11815, filed Sep. 12, 2001.

### FIELD OF THE INVENTION

This invention pertains to the field of chemical methods and to the use of the products obtained by these chemical methods.

### BACKGROUND

The products corresponding to the general formula (Id)

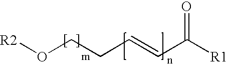

are known and described in the literature for their biological properties and more particularly for their cosmetic and pharmacological properties. Moreover, the principal lipid constituent of honeybee royal jelly, which is trans-10-hydroxy-2-decenoic acid (or DHA) corresponds to the general formula (Id) in which R₁═OH, R₂═H, n=1 and m=3.

Various methods for the preparation of unsaturated hydroxy fatty acids and their esters are disclosed in Lee et al., 1993, J. Org. Chem., Vol. 58, pages 2918-2919; Hurd and Saunders, 1952, J. Am. Chem. Soc., Vol. 74, pages 5324-5328; Krishnamurthy et al., 1989, Indian J. Chem. Sect. A, Vol. 28, pages 288-291; and Plettner et al., 1995, J. Chem. Ecol., Vol. 21, pages 1017-1030. Such methods have an oxidation step during which metallic salts such as chromium salts or manganese salts are employed. However, the use of metallic salts has a certain number of disadvantages. First, at the level of the products obtained by these methods, these products can be contaminated by the metallic salts. Thus, their cosmetic and/or pharmacological application is limited due to this contamination. Second, the use of metallic salts leads to a contamination of the environment of the factories in which the synthesis is performed.

It would therefore be advantageous to resolve the problems cited above by providing a novel and original route of synthesis capable of industrial transposition.

### SUMMARY OF THE INVENTION

This invention relates to a method of preparing unsaturated hydroxy fatty acids and esters thereof corresponding to general formula (Id):

Formula (Id)

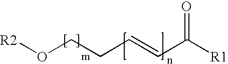

wherein n=1 to 4, m=2 to 16, R₁═OH, Cl, Br, OR₃ in which R₃ is a straight or branched alkyl, alkenyl or alkynyl radical of 1 to 16 carbons or glycerol esters, optionally substituted by one or more atoms selected from the group consisting of carbon, nitrogen, sulfur and halogens, R₂═H, SiR′₁R′₂R′₃ in which R′₁, R′₂ and R′₃ can be identical or different from each other and represent a straight or branched alkyl, alkenyl or alkynyl radical of 1 to 16 carbons or glycerol esters, optionally substituted by one or more atoms selected from the group consisting of carbon, nitrogen, sulfur and halogens, or R₂═C—Ar₃ with Ar representing an aryl radical optionally substituted by one or more atoms selected from the group consisting of carbon, nitrogen, sulfur and halogens, or R₂=a tetrahydropyranyl of formula:

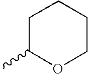

including causing a series of reactions according to a reaction diagram as follows:

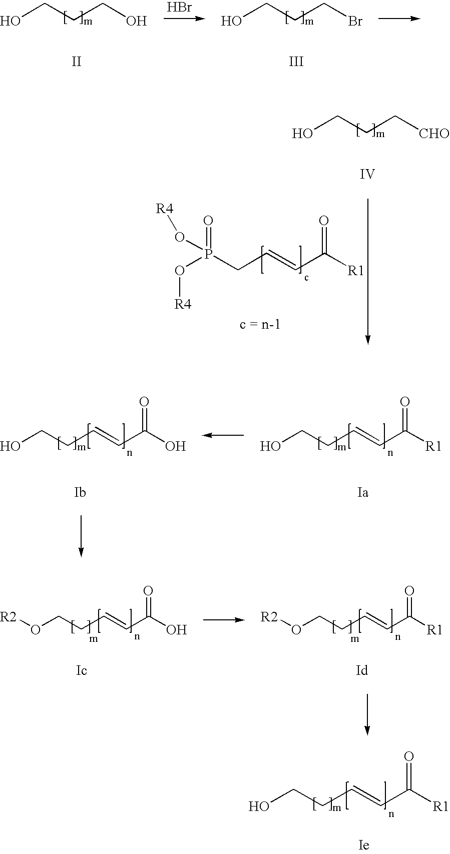

wherein R₁, R₂, m and n have the same meanings as in formula Id.

This invention also relates to a method of preparing unsaturated hydroxy fatty acids and esters thereof corresponding to general formula (Id):

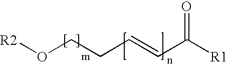

wherein n=1 to 4, m=2 to 16, R₁═OH, Cl, Br, OR₃ in which R₃ is a straight or branched alkyl, alkenyl or alkynyl radical of 1 to 16 carbons or glycerol esters, optionally substituted by one or more atoms selected from the group consisting of carbon, nitrogen, sulfur and halogens, R₂═H, SiR′₁R′₂R′₃ in which R′₁, R′₂ and R′₃ can be identical or different from each other and are a straight or branched alkyl, alkenyl or alkynyl radical of 1 to 16 carbons or glycerol esters, optionally substituted by one or more atoms selected from the group consisting of carbon, nitrogen, sulfur and halogens, or R₂═C—Ar₃ with Ar representing an aryl radical optionally substituted by one or more atoms selected from the group consisting of carbon, nitrogen, sulfur and halogens, or R₂=the tetrahydropyranyl of formula:

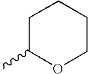

including a) brominating an initial diol of formula II:

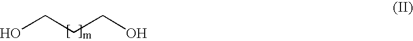

in an aqueous or nonaqueous solvent; b) oxidizing a bromide formed in step (a) in the presence of an optionally cyclic, optionally anhydrous tertiary amine N-oxide in the presence of DMSO to form an aldehyde of formula IV; c) subjecting the aldehyde formed in step (b) to a Wittig-Homer reaction; d) subjecting the product of step (c) to saponification to form a compound of general formula Ib:

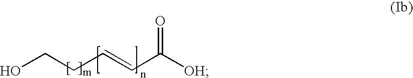

and

e) subjecting the compound of general formula (Ib) obtained in step (d) to a specific protection of an alcohol functional group in the presence of an acid catalyst.

In another aspect, the invention relates to methods of preventing or treating degradation of collagen, degradation of collagen by bacterial collagenases during a bacterial infection, regeneration of skin and ligaments, tumoral invasion and degenerative diseases having fibrinoid degeneration of collagen, as well as a method of reducing weight.

### DETAILED DESCRIPTION

This invention pertains to a method for the preparation of unsaturated hydroxy fatty acids and their esters corresponding to the following general formula (Id):

Formula (Id)

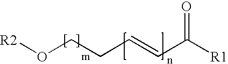

wherein n=1 to 4, m=2 to 16,

R₁═OH, Cl, Br, OR₃ in which R₃ is a straight or branched alkyl, alkenyl or alkynyl radical of 1 to 16 carbons or glycerol esters, optionally substituted by one or more atoms selected from the group consisting of carbon, nitrogen, sulfur and halogens,

R₂═H, SiR′₁R′₂R′₃ in which R′₁, R′₂ and R′₃ can be identical or different from each other and represent a straight or branched alkyl, alkenyl or alkynyl radical of 1 to 16 carbons or glycerol esters, optionally substituted by one or more atoms selected from the group consisting of carbon, nitrogen, sulfur and halogens,

or R₂═C—Ar₃ with Ar representing an aryl radical optionally substituted by one or more atoms selected from the group consisting of carbon, nitrogen, sulfur and halogens,

or R₂=a tetrahydropyranyl of formula:

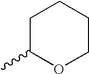

The invention also pertains to the use of the products as an anticollagenase agent, lipolytic agent or antiacne agent in a pharmaceutical and/or cosmetic preparation.

The method of the invention is remarkable in that it enables a more rapid synthesis method with better yields than the methods previously known in the art. The method of the invention makes it possible to eliminate from the first steps of other methods the chromatographic procedures which are not industrial purification techniques.

The general synthesis diagram is the following:

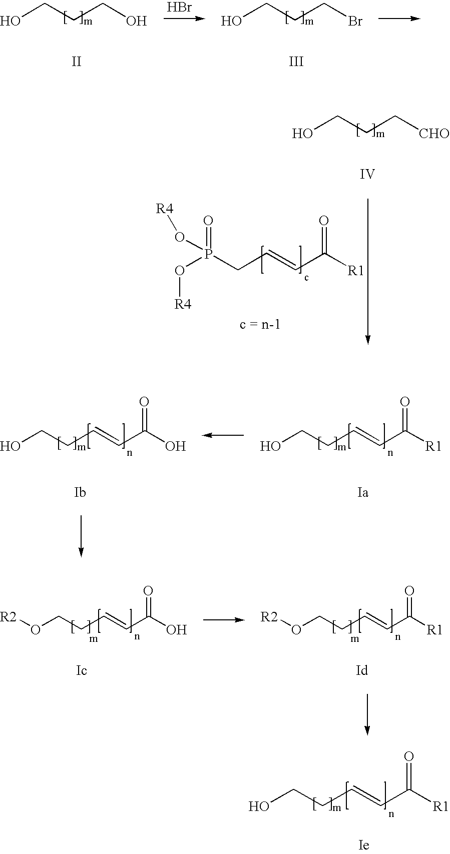

in which R₁, R₂, m and n have the same meaning as in formula (Id).

The first step of the synthesis is a bromination and the initial compound of the reaction is a diol of formula (II). Numerous techniques enabling bromination are known and can be used by those skilled in the art in this step. This bromination requires the use of a solvent which can be, especially, toluene, benzene, dimethylformamide, tetrahydrofuran, cyclohexane, heptane, petroleum ether, and the like. The reagent used in this bromination step can be aqueous or nonaqueous HBr, Ph₃P,Br₂, carbon triphenylphosphine tetrabromide or hydrobromic acid. The experimental bromination conditions using aqueous HBr described in Geresh et al., Tetrahedron Asymmetry, 1998, Vol. 9, pages 89-96 are an example.

The second step is an oxidation of an aldehyde of formula (IV) in the presence of an optionally cyclic, optionally anhydrous tertiary amine N-oxide in the presence of DMSO. At the end of the reaction, the corresponding tertiary amine bromhydrate is eliminated by simple filtration. The optionally cyclic, optionally anhydrous tertiary amine N-oxides present in the second step are advantageously selected from among N-methyl morpholine oxide, trimethylamine oxide or triethylamine oxide or a mixture thereof. Known in the prior art are other techniques enabling synthesis of aldehydes of general formula IV. However, step 2 of the method of this invention makes it possible to resolve the drawbacks of the known techniques. The oxidation reaction in the presence of manganese salts of the corresponding cyclic alkenes (Lee et al., 1993, J. Org. Chem., Vol. 10, pages 2918-2919) is an example.

Step 2 of the method thus makes it possible to avoid a step involving the presence of metallic salts. The article by Guindon et al. of 1984 (J. Org. Chem., Vol. 49, pages 3912-3920) describes the synthesis of 8-hydroxy-octanal from 1,1-dimethoxy-8-methoxymethoxy-octane. However, the synthesis yield of 8-hydroxy-octanal is relatively low (36%), whereas step 2 of the invention makes it possible to obtain higher yields. The other techniques known in the prior art enabling synthesis of aldehydes of general formula IV are lengthy synthesis methods involving more than 4 steps.

Step 3 of the method of the invention is a Wittig-Homer reaction. This reaction is known (Modern Synthetic Reaction. Second edition, Herbert O. House, Wittig Homer reaction, pages 682-703) and experimental conditions known in the art can be used in the framework of this invention. As an example, the Wittig-Homer reaction can be performed in the presence of triethylphosphonoacetate and potassium carbonate.

Step 4 of the method of the invention is a saponification step. No particular experimental condition is implemented in the method of the invention. Those skilled in the art can use suitable experimental conditions for this step.

Step 5 of the method is a step of specific protection of the alcohol functional group of the compound of general formula Ib obtained in step 4. This reaction is performed in any enol ether in the presence of an acid catalyst. The reaction is advantageously performed in dihydropyrane in the presence of PTSA (para toluene sulfonic acid). The product of general formula Ic obtained after step 5 is purified by simple aqueous washing and drying over sulfate. Steps 2 and 5 of the method of the invention are not described in the state of the art. They make it possible to resolve the technical problems described above while also increasing the yield and the rapidity of the method for the synthesis of the compounds of general formula I.

The product of formula (Id) obtained in step 5 of the method of the invention can be subjected to a final deprotection to obtain the compound of general formula (Ie). This deprotection is performed in a solution of methanol containing an acid catalyst. Any acid catalyst can be used in the invention. The acid catalyst employed is advantageously PTSA.

The product of formula (Id) obtained in step 5 of the method of the invention can be used in an esterification reaction of the glycerol. Depending on the relative quantities of glycerol used, it is possible to obtain monoesters (2 possible isomers: in position 1 and 2), diesters (2 possible isomers: diesters 1.1 and 1.2) and triesters. After the step of esterification of the glycerol, the compound obtained can undergo a final deprotection under experimental conditions substantially the same as the deprotection conditions of the product of formula (Id) cited above.

The products obtained by the method are, as indicated above, used in the cosmetic and/or pharmaceutical field. Products obtained by the method of the invention followed by a final deprotection step have anticollagenase activity.

Collagen is the most abundant and important protein of the human body and the skin. This scleroprotein represents notably 75% of the proteins of the dermis to which it provides solidity. The fibroblasts create precollagen molecules which are transformed in the presence of vitamin C into collagen molecules form the amino acids (hydroxyproline, lysine, proline). The collagen must create bonds among these different molecules to form a network of fibrils.

Collagen renewal changes with age. The soluble collagen which bestows suppleness and resistance to the skin and the mucosa degrades increasingly rapidly under the influence of the proteolytic enzyme collagenase, which leads at the dermal level to an aging of the fibrous structure of the proteins. Moreover, the insoluble collagen which leads to a loss of elasticity becomes rigid as it polymerizes with the glucose molecules as a result of multiple bonds which are difficult to reverse (glycation phenomenon). These bonds make the collagen more resistant to attack by collagenases which leads to an increasing rigidity of the collagen fibers. This hardening phenomenon, characteristic of aged cutaneous tissues, must be combated as early as possible because it increases the destruction of fibroblasts by free radicals, but also the denaturation of the dermal proteins.

The collagenases are enzymes that are weakly expressed under normal physiological conditions. Their overexpression in aging and, in particular, during menopause in females, lead to greater denaturation of the dermal fibrous proteins. However, destruction of collagen fibers can take place under circumstances other than aging. In fact, during a bacterial infection, bacterial collagenases can destroy the collagen fibers of the infected host.

Moreover, tumoral invasion requires a degradation of the basal membrane and the extracellular matrix and of all of the structural proteins of these components which include collagen. There has, therefore, been demonstrated a very clear relationship between the invasive power of tumors and the presence of collagenase activity in human tumors. Collagenases are found at the level of tumor cells, but also in the fibroblasts surrounding the tumor. Normal epithelial cells secrete a very small amount of collagenases whereas these proteins are overexpressed by invasive or metastatic tumor cells.

Other degenerative diseases display a fibrinoid degeneration of collagen and are also referred to as “collagen diseases”.

The invention therefore pertains to the use of products that can be obtained by the method of the invention as active anticollagenase agents. Trans-10-hydroxy-2-decenoic acid (DHA) and the glycerol ester of trans-10-hydroxy-2-decenoic acid (glycerol monoester in position 1) demonstrated anticollagenase activity. The invention also pertains to the use of trans-10-hydroxy-2-decenoic acid (DHA) and the glycerol ester of trans-10-hydroxy-2-decenoic acid as an anticollagenase agent in a pharmaceutical and/or cosmetic preparation.

The invention pertains to the use of trans-10-hydroxy-2-decenoic acid (DHA) and the glycerol ester of trans-10-hydroxy-2-decenoic acid as a drug intended for the prevention of or to cure degradation of collagen. This drug is most particularly intended to prevent or cure the degradation of collagen by bacterial collagenases during a bacterial infection.

The invention also pertains to the use of trans-10-hydroxy-2-decenoic acid (DHA) and/or the glycerol ester of trans-10-hydroxy-2-decenoic acid as a drug for regenerating skin and ligaments.

The invention also pertains to the use of trans-10-hydroxy-2-decenoic acid (DHA) and/or the glycerol ester of trans-10-hydroxy-2-decenoic acid as a drug to prevent or cure tumoral invasion.

The invention also pertains to the use of trans-10-hydroxy-2-decenoic acid (DHA) and/or the glycerol ester of trans-10-hydroxy-2-decenoic acid as a drug to prevent or cure degenerative diseases displaying fibrinoid degeneration of the collagen and also referred to as “collagen diseases”.

As stated above, the products obtained by the method of the invention are used in the cosmetology and/or pharmaceutical field. We demonstrated that the products obtained by the method of the invention followed by a final deprotection step and, more particularly, trans-10-hydroxy-2-decenoic acid (DHA), have lipolytic activity. Consequently, the products obtained by the method of the invention followed by a final deprotection step and, more particularly, DHA, can especially be employed in weight-reduction treatments and in any treatment known to require a lipolytic activity.

The products obtained by the method of the invention are, as stated above, used in the cosmetology and/or pharmaceutical field. We demonstrated that the products obtained by the method of the invention followed by a final deprotection step, more particularly, trans-10-hydroxy-2-decenoic acid (DHA) have an antiacne activity.

The treatment of acne requires the treatment of two major problems which are, on the one hand, seborrhea, and, on the other hand, bacterial proliferation responsible for cutaneous inflammation. We demonstrated that the method of the invention followed by a final deprotection step and, more particularly, DHA, display both sebum-regulatory and antibacterial activity.

DHA is capable of inhibiting cutaneous 5-alpha-reductase, the enzyme responsible for the production of di-hydro-testosterone. Treatment with 0.1% of DHA and treatment with 0.5% of DHA reduced by about 70% and about 90%, respectively, the 5-alpha-reductase activity compared to an untreated control. This inhibition results in a considerable reduction of the sebum level.

Furthermore, 0.5% of DHA has, after 14 or 28 days of treatment, a bactericidal effect of about 95 to 100% tested on Propionibacterium acnes, Staphylococcus aureus and Malassezia furfur.

Other advantages and characteristics of the invention will become apparent from the examples below pertaining to the synthesis methods of the invention and the anticollagenase and lipolytic properties of the products that can be obtained by the synthesis methods of the invention.

### EXAMPLE 1

### Operating Mode for Synthesis of Ia (n=6, m=6, R1=OEt) and Ie (Glycerol triester)

1. Step 1: Bromination

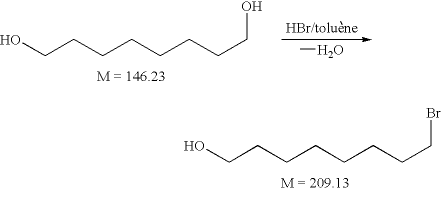

438 g (3 mol) of 1,8-octanediol was dissolved in 3 1 of toluene. 375 ml (3.3 mol) of aqueous 48% HBr was then added. The medium was then heated to eliminate water that was present and water formed during the reaction by azeotropic distillation. After 13.5 h of contact, the medium was cooled and taken up with a saturated solution of NaHCO₃. The organic phase was separated and washed with a saturated solution of NaCl. After drying over MgSO₄, the medium was concentrated to yield a crude product of 672 g.

The 8-bromooctanol was purified by distillation under reduced pressure, at 96° C. under P<1 mbar, m=575 g (92%).

Characterization

TLC: Rf=0.8 (heptane/ether iso 8/2)

¹H NMR (200 MHz, CDCl₃): 3.65 (t, 2H, J=6.4 Hz); 3.43 (t, 2H, J=6.8 Hz); 1.87 (m, 2H); 1.36-1.69 (m, 10H).

2. Step 2: Oxidation in Aldehyde

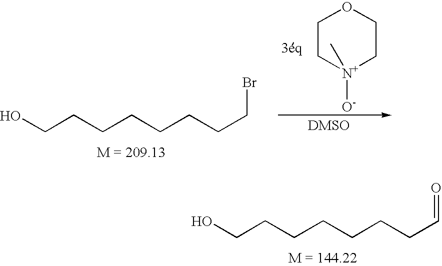

708 g (5.87, 3 eq) of anhydrous N-methylmorpholine N-oxide was dissolved under N₂ in 3 l of DMSO. 410 g (1.96 mol) of 8-bromooctanol dissolved in 1 l of DMSO was then added over 30 minutes. The medium became clear. N-methylmorpholine ammonium bromide precipitated. After 65 h of agitation at ambient temperature, the salt was filtered and the medium was taken up with 4 l of a saturated solution of NaCl. After extraction with 4×1 l of ethyl acetate and drying, 320 g of crude product, constituted of 74% of aldehyde (yield=83%) and 26% of 1,8-octanediol.

Characterization

TLC: Rf=0.6 (heptane/ethyl acetate 8/2)

¹H NMR (400 MHz, CDCl₃): 9.74 (t, 1H, J=1.7 Hz); 3.61 (t, 2H, J=6.6 Hz); 2.41 (dt, 2H, J=1.7 and 7.3 Hz); 1.51-1.65 (m, 4H); 1.24-1.37 (m, 6H).

3. Step 3: Wittig-Homer Reaction

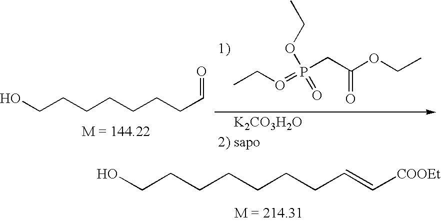

The preceding crude product (320 g) was dissolved in 3 l of water. 800 ml (4.2 mol, 2.1 eq) of triethylphosphonoacetate was then added followed by 830 g (6 mol) of potassium carbonate. After 20 h of agitation, the reaction was terminated. The medium was extracted by 4×1 l of isopropyl ether. After drying over MgSO₄, the organic phases were evaporated and yielded 650 g of crude product.

The product was purified either by distillation E=120° C. under P<1 mbar. 280 g of a colorless liquid found to conform by NMR (yield=80% from the aldehyde or 66% from the brominated derivative) was recovered.

Or the product was purified by chromatography with a heptane/ethyl acetate 8/2 elution. In that case, 119.6 g of products were obtained (28% from the brominated derivative).

Characterization

TLC: Rf=0.8 (heptane/ethyl acetate 8/2)

¹H NMR (400 MHz, CDCl₃): 6.91-6.99 (m, 1H); 5.78-5.82 (dt, 1H, J=1.4 and 15.6 Hz); 4.17 (q, 2H, J=7.1 Hz); 3.63 (t, 2H, J=6.6 Hz); 2.18 (dq, 2H, J=1.2 and 7.3 Hz); 1.22-1.65 (m, 11H).

4. Step 4. Saponification Reaction

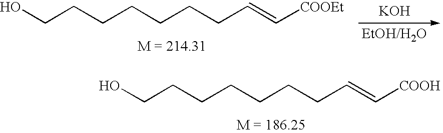

119.6 g (0.56 mol) of hydroxyester was dissolved in 600 ml of ethanol and 400 ml of a 4.6 N solution of KOH was added. The medium was agitated for 8 h. The medium was extracted with isopropyl ether. The aqueous phase was acidified to pH=1 and extracted with ethyl acetate. After drying and evaporation, 99.6 g of pink solids were obtained. The solids were recrystallized in an isopropyl ether/petroleum ether mixture. The product was obtained in the form of a white solid (86 g, 83%).

Characterization

TLC: Rf=0.2 (heptane/ethyl acetate 7/3)

Melting point: mp=61.3° C.

¹H NMR (400 MHz, CDCl₃): 7.06 (dt, 1H, J=15.6 and 7 Hz); 5.81 (dt, 1H, J=1.5 and 15.6 Hz); 3.64 (t, 2H, J=6.6 Hz); 2.22 (dq, 2H, J=1.2 and 7.3 Hz); 1.52-1.58 (m, 2H); 1.45-1.48 (m, 2H); 1.33-1.3765 (m, 6H).

5. Step 5: Protection Reaction

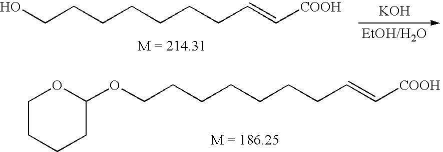

86 g (0.46 mol) of hydroxy acid was put in solution with 45 ml (0.48 mol) of 3,4-dihydro-2H-pyran in 500 ml of THF. 1 ml of concentrated HCl was added and the medium agitated for 24 h.

The THF was then concentrated, the crude product was taken up with ethyl acetate and washed with a saturated solution of NaCl until neutral pH. After drying over MgSO₄, 132 g of crude product was obtained (>100%).

Characterization

TLC: Rf=0.4 (heptane/ethyl acetate 7/3)

¹H NMR (400 MHz, CDCl₃): 7.06 (dt, 1H, J=15.6 and 7 Hz); 5.81 (dd, 1H, J=1.6 and 15.6 Hz); 4.58 (t, 1H, J=2.8 Hz); 3.82-3.91 (m, 1H); 3.71-3.73 (m, 1H); 3.51-3.52 (m, 1H); 3.36-3.69 (m, 1H); 2.20 (m, 2H); 1.33-1.89 (m, 16H).

6. Step 6: Esterification Reaction of the Glycerol

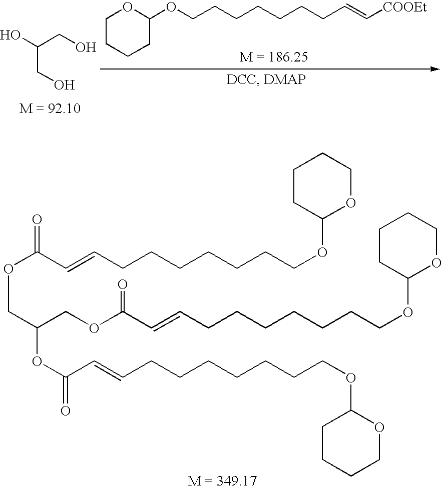

8.4 g (0.091 mol) of glycerol was put into solution in 500 ml of dichloromethane. The preceding crude product (0.46 mol), after elimination of traces of water by azeotropic distillation, was dissolved in 500 ml of dichloromethane and added to the medium. 56.8 g (0.46 mol) of dimethylamino pyridine was then added followed by 97 g (0.46 mol) of dicyclohexylcarbodiimide. The medium was agitated for 70 h. A precipitate appeared and was filtered.

The medium was concentrated and taken up in isopropyl ether. After filtration and concentration, 156 g of crude product was obtained and purified by chromatography and with a 7/3 heptane/ethyl acetate elution.

99 g of a fraction containing ⅔ product and ⅓ acyl urea was obtained.

Characterization

TLC: Rf=0.7 (heptane/ethyl acetate 7/3)

¹H NMR (400 MHz, CDCl₃): 6.96 (m, 3H); 5.80 (dd, 3H, J=1.6 and 15.6 Hz); 5.29-5.31 (m, 1H); 4.54-4.57 (m, 3H); 4.20-4.39 (m, 4H); 3.81-3.89 (m, 3H); 3.68-3.72 (m, 3H); 3.41-3.49 (m, 3H); 3.34-3.39 (m, 3H); 2.25-2.18 (m, 6H); 1.33-1.99 (m, 48H).

7. Step 7: Final Deprotection

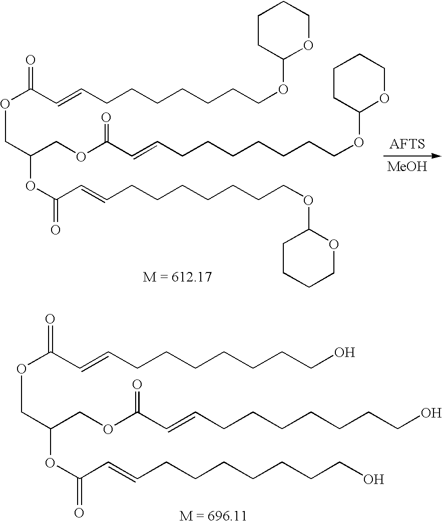

99 g (0.136 mol) of the preceding mixture was dissolved in 1 l of methanol with 9.9 g of PTSA. The medium was agitated for 14 h. The reaction was terminated. The medium was then concentrated. The oil obtained was then taken up with H₂O and brought to pH=6 with a saturated solution of NaHCO₃. The aqueous phase was extracted with dichloromethane. After drying of the organic phase and evaporation, 77 g of a yellow oil was obtained.

The product was purified by chromatography on silica CH₂Cl₂/acetone 9/1 to 1/1 and CH₂Cl₂/methanol 95/5.

27 g of product was obtained in the form of an oil which crystallized in the form of an amorphous yellowish white solid with a purity between 85 and 90%.

Characterization

TLC: Rf=0.2 (CH₂Cl₂/acetone 9/1)

¹H NMR (400 MHz, CDCL₃): 6.94-7.01 (m, 3H); 5.78-5.84 (m, 3H); 5.29-5.31 (m, 1H); 4.20-4.34 (m, 4H); 3.60-3.65 (m, 6H); 2.16-2.22 (m, 6H); 1.33-1.99 (m, 30H).

### EXAMPLE 2

### Operating Mode for the Synthesis of

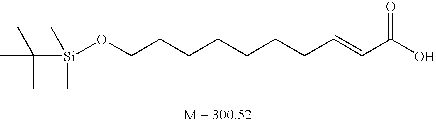

1. Step 1: Protection of 8-bromooctanol

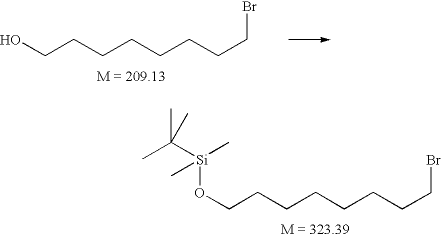

21 g (0.1 mol) of 8-bromooctanol was dissolved in 200 ml of dichloromethane. 16 g (0.104 mol) of terbutyldimethylsilyl chloride was then added at 0° C., followed by 7.5 g (0.11 mo) of imidazole. A precipitate was formed instantaneously. After 3 h of agitation, the medium was filtered, concentrated and the crude product was distilled.

25.8 g of product was thus isolated at 99-104° C. under P<1 mbar (82%).

Characterization:

¹H NMR (400 MHz, CDCl₃): 3.59 (t, 2H, J=6.6 Hz); 3.39 (t, 2H, J=6.9 Hz); 1.82-1.89 (m, 2H); 1.30-1.50 (m, 10H); 0.88 (t, 9H, J=2.7 Hz); 0.04 (s, 6H).

2. Step 2: Oxidation in Aldehyde

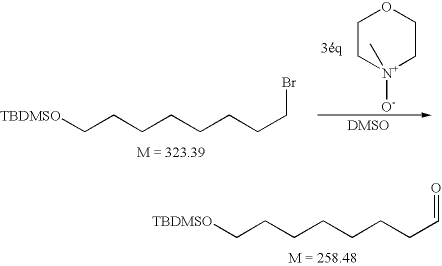

20 g (61 mmol) of silyl derivative was put into solution in 200 ml of DMSO. 21.7 g (0.18 mol) of N-methylmorpholine N-oxide was then added. The medium was agitated for 72 h. A precipitate appeared. The medium was diluted with saturated NaCl then extracted with isopropyl ether. After drying and evaporation, 15.3 g of crude product was obtained.

The product was purified by distillation at 81° C. under P<1 mbar (9 g, 57%).

Characterization

¹H NMR (400 MHz, CDCl₃): 9.76 (t, 1H, J=1.9 Hz); 3.59 (t, 2H, J=6.6 Hz); 2.42 (dt, 2H, J=1.8 and 7.2 Hz); 1.49-1.68 (m, 4H); 1.30-1.32 (m, 6H); 0.88 (t, 9H, J=2.7 Hz); 0.04 (t, 6H, J=2.9 Hz).

3. Step 3: Wittig Reaction

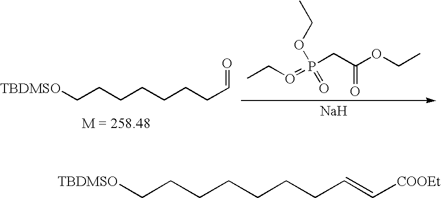

835 mg (21 mmol) of NaH was put into solution with 5 ml of THF and cooled to T<0° C. 4.2 ml (22 mmol) of triethylphosphonoacetate was added drop by drop. After 3 h of agitation at ambient temperature, 5 g (19 mmol) of aldehyde was added in the cold state and agitation was maintained for 17 h. After hydrolysis with H₂O, extraction with ethyl acetate, drying and evaporation, 6.7 g of crude product was obtained.

3.7 g of product was obtained by purification on silica gel (heptane/ethyl acetate 8/2 elution) (60%).

Characterization

TLC: Rf=0.6 (heptane/ethyl acetate 8/2)

¹H NMR (400 MHz, CDCl₃): 6.95 (dt, 1H, J=8.6 and 15.6 Hz); 5.79 (dt, 1H, J=1.4 and 15.8 Hz); 4.17 (q, 2H, J=7.1 Hz); 3.58 (dt, 2H, J=6.6 and 9.8 Hz); 2.15-2.21 (m, 2H); 1.46-1.51 (m, 4H); 1.24-1.42 (m, 9H); 0.88 (t, 9H, J=2.7 Hz); 0.04 (t, 6H, J=2.9 Hz).

4. Step 4: Saponification

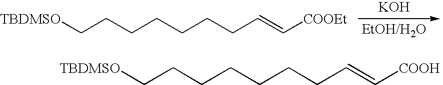

2 g (6 mmol) of ester was dissolved in 10 ml of ethanol and 5 ml of a 3.8 N solution of NaOH was added. The reaction was terminated in 4 h. The medium was acidified to pH=1 and extracted with ethyl acetate. The product was thereby obtained without additional purification (1.5 g, 83%).

Characterization

TLC: 0.2 (heptane/ethyl acetate 7.3)

¹H NMR (400 MHz, CDCl₃): 7.07 (dt, 1H, J=8.6 and 15.6 Hz); 5.81 (dt, 1H, J=1.4 and 15.6 Hz); 3.59 (dt, 2H, J=6.6 and 9.8 Hz); 2.21-2.27 (m, 2H); 1.46-1.51 (m, 4H); 1.24-1.42 (m, 6H); 0.89 (t, 9H, J=2.7 Hz); 0.04 (t, 6H, J=2.9 Hz).

### EXAMPLE 3

### Evaluation of the Anticollagenase Activity of Products Obtained by the Method of the Invention on Frozen Sections of Human Skin

1. Operating Mode

This example was performed with different solutions at concentrations of 1 and 2% of active principles in comparison with the excipient alone, buffer controls and collagenase. The active principles used were DHA, the 2-dimethylamino ethyl ester of trans-10-hydroxy-2-decenoic acid (ML40) and the glycerol ester of trans-10-hydroxy-2-decenoic acid (GM). Table 1 lists the different solutions tested.

TABLE 1

| | Solution | | | | | | | | | | | | |
|---|---|---|---|---|---|---|---|---|---|---|---|---|---|
| | 1 | 2 | 3 | 4 | 5 | 6 | 7 | 8 | 9 | 10 | 11 | 12 | 13 |
| DHA | 2% | | | 1% | | | 2% | | | 1% | | | |
| ML40 | | 2% | | | 1% | | | 2% | | | 1% | | |
| GM | | | 2% | | | 1% | | | 2% | | | 1% | |
| Collagen- | | | | | | | 30 | 30 | 30 | 30 | 30 | 30 | 30 |
| ase(U/ml) | | | | | | | | | | | | | |

Frozen 5-μm-thick sections from a mammary plasty of a 54-year-old woman were placed on histological slides (4 sections per slide). Each solution was tested on one slide.

The sections were covered with the solutions to be tested then incubated for 2 hours at 37° C. in a humid chamber. The solutions were eliminated by repeated rinsings and the sections were stained with picrosirius. Microscopic examination was performed with the 2.5 objective and paper photographs were taken with Kodak Gold 100 ASA film.

2. Results

Table 2 summarizes the results of alteration of the collagen structure as a function of the tested solution. An absence of alteration of the collagen structure is indicated by 0 while a somewhat or markedly to very strongly altered collagen structure is indicated, respectively, by 1 or 2.

TABLE 2

| Solution | 1 | 2 | 3 | 4 | 5 | 6 | 7 | 8 | 9 | 10 | 11 | 12 | 13 |
|---|---|---|---|---|---|---|---|---|---|---|---|---|---|
| DHA | 2% | | | 1% | | | 2% | | | 1% | | | |
| ML40 | | 2% | | | 1% | | | 2% | | | 1% | | |
| GM | | | 2% | | | 1% | | | 2% | | | 1% | |
| Collagen- | | | | | | | 30 | 30 | 30 | 30 | 30 | 30 | 30 |
| ase U/ml | | | | | | | | | | | | | |
| Alteration | 0 | 0 | 0 | 0 | 0 | 0 | 0 | 1 | 1 | 0 | 2 | 2 | 2 |
| of the | | | | | | | | | | | | | |
| collagen | | | | | | | | | | | | | |
| structure | | | | | | | | | | | | | |

Moreover, application of the buffer control Tris or the excipient did not induce alteration of the collagen structure. Consequently, the product DHA at 1 and at 2% inhibited completely the activity of collagenase, whereas the products ML40 and GM at 2% only slightly inhibited the activity of collagenase.

### EXAMPLE 4

### Evaluation of the Anticollagenase Activity of GM Obtained by the Method of the Invention on Human Skin Explants Maintained in Survival State

1. Operating Mode

The study was performed on a 5% GM product in comparison with the excipient (hydrocerin), a positive control and a control in the presence of collagenase at 100 U/ml.

Hydrocerin was used as the excipient for the preparation of the product to be applied. This study was performed twice. In the first study, it was found that the action of collagenase on Day 2 remained very limited and insignificant. In the second study, the study time was extended and the collection of the explants was performed on Day 2 and on Day 4.

a. Preparation of the Explants

Human skin explants prepared and distributed into 16 lots of three explants each were placed in survival state according to Table 3.

TABLE 3

| | Day 2 | Day 3 |
|---|---|---|
| Control | 3 explants | 3 explants |
| Excipient | 3 explants | 3 explants |
| Product containing 5% GM | 3 explants | 3 explants |
| Positive control | 3 explants | 3 explants |
| Control + collagenase | 3 explants | 3 explants |
| Excipient + collagenase | 3 explants | 3 explants |
| Product containing 5% GM + collagenase | 3 explants | 3 explants |
| Positive control + collagenase | 3 explants | 3 explants |

b. Application of the Product Containing 5% GM

The product was applied on Day 0 and on Day 2 at the rate of 20 mg per explant and collagenase was incorporated into the culture medium of the last 24 lots.

c. Histology

Three explants of each lot were collected on Day 2 and on Day 4, fixed in ordinary Bouin's fixative and subjected to histological processing.

The histological study comprised:

impregnation in paraffin,

sections,

staining with Sirius red F3B,

calorimetric measurements of the collagen by image analysis,

comparison with photographs.

2. Results

The samples collected on Day 2 did not reveal significant collagenase activity in the lots examined. For this reason, the survival, the contact and the application were extended to Day 4. The collagenase action was monitored in two ways: intensity of the coloration of the collagen network and thickness of the dermal structure. With this study, penetration of the active principle and its inhibitory activity were correlated in relation to collagenase. The results obtained were as follows:

for the controls without collagenase, the dermis had a normal structure with regular bundles of collagen in all of the compartments;

for the controls with collagenase, the collagen bundles were strongly degraded and the thickness of the dermis had diminished by half;

for the explants with excipient and collagenase, the collagen bundles were strongly degraded, but to a lesser degree than that seen with the controls with collagenase, and the thickness of the dermis had diminished by almost half;

for the explants with the product containing 5% of GM and collagenase, the collagen bundles were very slightly degraded and the thickness of the dermis had diminished slightly;

for the explants with positive control (phenanthroline) and collagenase, the dermal structure was the same as that of the controls without collagenase.

Under these experimental conditions, the GM product demonstrated a pronounced anticollagenase activity.

### EXAMPLE 5

### Evaluation of the Antilipolytic of DHA Obtained by the Method of the Invention on Adipose Tissue Explants ex vivo

1. Operating Mode

DHA was incorporated in the culture medium at a final concentration of 0.25 and 0.5%. After 8 days of contact, the activity was evaluated by quantitative determination of the lipids distributed in the culture medium.

a. Preparation of the Explants

Twelve adipose tissue explants (plasty P202-AB31) were prepared and placed in survival state in BEM medium (BIO-EC's Explants Medium). The explants were distributed in 4 lots of 3 explants:

one control lot,

one positive control lot (caffeine at 0.1%),

two product lots (DHA at 0.25 and 0.5%).

b. Application of the Products

On Day 0, the explants were placed in survival state in 2 ml of culture medium, in which the product to be tested was incorporated.

This treatment was renewed on Day 2, Day 4 and Day 6.

c. Samples

On Day 2, Day 4, Day 6 and Day 8, the culture medium was collected. For each explant, the media collected on Day 2, Day 4, Day 6 and Day 8 were grouped together in the same tube and preserved at −20° C. for quantitative determination of the lipids.

On Day 8, the adipose tissue explants were collected and fixed in ordinary Bouin's fixative for the histological study.

d. Histology

The fixed adipose tissue explants were dehydrated, impregnated with paraffin, but in block form, sectioned and stained with Masson's trichrome.

e. Quantitative Determination of the Lipids

After extraction of the culture medium, the lipids were separated and quantitatively determined by TLC.

2. Results

The viability and morphology of the adipocytes was monitored by the histologic study.

The lipolytic activity was evaluated by analysis of the proportions of monoglycerides, diglycerides, triglycerides and free fatty acids.

a. Histology

After 8 days of maintenance in the survival state, the controls and treated explants displayed no visible alterations nor cellular necroses.

b. Quantitative Determination of the Lipids

The results obtained are presented in Table 4 below. The results are expressed in mass (μg) of each category of lipid released in the culture medium during the 8 days of treatment.

TABLE 4

| | Monoglycerides | | Diglycerides | | Fatty acids | | Triglycerides | |
|---|---|---|---|---|---|---|---|---|
| | | Standard | | Standard | | Standard | | Standard |
| μg | Mean | deviation | Mean | Deviation | Mean | Deviation | Mean | Deviation |
| Control | 4.58 | 2.15 | 0.04 | 0.04 | 0.97 | 0.09 | 106.07 | 9.90 |
| Caffeine | 1.22 | 0.44 | 0.02 | 0.01 | 27.99 | 4.24 | 197.34 | 15.17 |
| 0.1% | | | | | | | | |
| DHA/JLB at | 3.64 | 0.12 | 0.00 | 0.00 | 11.42 | 1.12 | 156.15 | 10.65 |
| 0.25% | | | | | | | | |
| DHA/JLB at | 7.06 | 2.68 | 0.00 | 0.00 | 11.53 | 1.09 | 202.56 | 45.32 |
| 0.5% | | | | | | | | |

Table 5 below represents the statistical analysis using Student's test of the results of the quantitative determination of the fatty acids released in the culture medium during the 8 days of treatment.

TABLE 5

| | Control | Caffeine | DHA at 0.25% | DHA at 0.5% |
|---|---|---|---|---|
| | 1.10 | 33.89 | 9.95 | 12.81 |
| | 0.94 | 24.10 | 11.67 | 11.64 |
| | 0.87 | 25.97 | 12.66 | 10.14 |
| Mean/ | 0.97 | 27.99 | 11.42 | 11.53 |
| Standard | 0.1 | 4.2 | 1.1 | 1.1 |
| deviation | | | | |

| | | | |
|---|---|---|---|
| % augmentation/ | 2780.6 | 1075.6 | 1086.8 |
| Control/Probability “p” | 0.012 | 0.005 | 0.005 |

An important parameter in this example was the variation of the quantity and the percentage of the fatty acids released in the culture medium after the treatment period.

Compared to the untreated control, an augmentation by a factor of about 29 (2780%) for the positive control (caffeine at 0.1%) was observed.

DHA at 0.25 and 0.5% led to a significant augmentation respectively of 1075 and 1087%. The augmentation of the concentration used did not have an effect on the efficacy. It would appear that the maximum effective dose is on the order of 0.25%.

Under the operating conditions described above and according to Student's test, DHA applied at 0.25 and 0.5% has a significant lipolytic activity compared to that of caffeine.

1. A method of preparing unsaturated hydroxy fatty acids and esters thereof corresponding to general formula (Id):
Formula (Id) 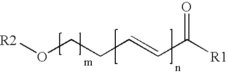
wherein n=1 to 4, m=2 to 16,
R₁═OH, Cl, Br, OR₃ in which R₃ is a straight or branched alkyl, alkenyl or alkynyl radical of 1 to 16 carbons or glycerol esters, optionally substituted by one or more atoms selected from the group consisting of carbon, nitrogen, sulfur and halogens,
R₂═H, SiR′₁R′₂R′₃ in which R′₁, R′₂ and R′₃ can be identical or different from each other and are a straight or branched alkyl, alkenyl or alkynyl radical of 1 to 16 carbons or glycerol esters, optionally substituted by one or more atoms selected from the group consisting of carbon, nitrogen, sulfur and halogens,
or R₂═C—Ar₃ with Ar representing an aryl radical optionally substituted by one or more atoms selected from the group consisting of carbon, nitrogen, sulfur and halogens,
or R₂=the tetrahydropyranyl of formula: 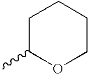
comprising causing a series of reactions according to a reaction diagram as follows: 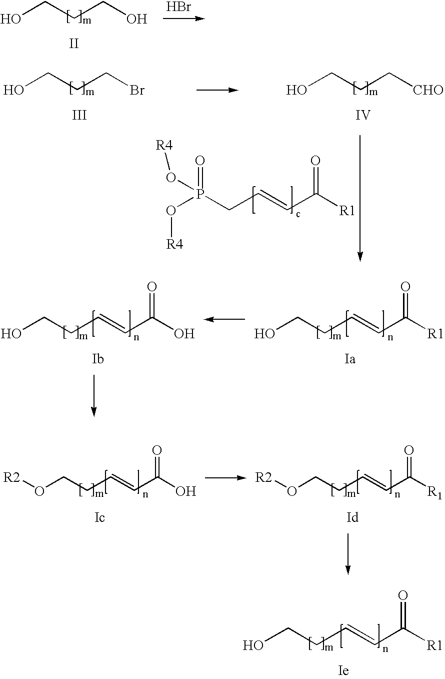
wherein R₁, R₂, m and n have the same meanings as in formula Id.

2. The method according to claim 1, wherein a first step in the reaction diagram is a bromination, with an initial compound being a diol of formula (II).

3. The method according to claim 2, wherein the first step uses a solvent.

4. The method according to claim 3, wherein the solvent is selected from the group consisting of toluene, benzene, dimethylformamide, tetrahydrofuran, cyclohexane, heptane and petroleum ether.

5. The method according to claim 1, wherein a reagent used in a first step in the reaction diagram is selected from the group consisting of aqueous or nonaqueous HBr, Ph₃P,Br₂, carbon triphenylphosphine tetrabromide and hydrobromic acid.

6. The method according to claim 1, wherein a second step in the reaction diagram is an oxidation in aldehyde of formula (IV) in the presence of an optionally cyclic, optionally anhydrous tertiary amine N-oxide and in the presence of DMSO.

7. The method according to claim 6, wherein the optionally cyclic, optionally anhydrous tertiary amine N-oxide is selected from the group consisting of N-methylmorpholine oxide, trimethylamine oxide, triethylamine oxide and mixtures thereof.

8. The method according to claim 1, wherein a third step in the reaction diagram is a Wittig-Homer reaction and a fourth step in the reaction diagram is a saponification reaction.

9. The method according to claim 8, wherein the Wittig-Horner reaction is carried out in the presence of triethylphosphonoacetate and potassium carbonate.

10. The method according to claim 1, wherein a fifth step in the reaction diagram is a specific protection of an alcohol functional group of the compound of general formula (Ib) obtained in a fourth step in the reaction diagram.

11. The method according to claim 1, wherein a fifth step in the reaction diagram is carried out in an enol ether in the presence of an acid catalyst.

12. The method according to claim 1, wherein a fifth step in the reaction diagram carried out with dihydropyrane in the presence of PTSA (para-toluene sulfonic acid).

13. The method according to claim 1, wherein a product of formula (Id) obtained in a fifth step in the reaction diagram is subjected to a final deprotection to obtain the compound of general formula (Ie).

14. The method according to claim 1, wherein a product of formula (Id) obtained in a fifth step in the reaction diagram is used in an esterification reaction of the glycerol prior to undergoing final deprotection.

15. The method according to claim 13, wherein the deprotection is carried out in a methanol solution containing an acid catalyst.

16. The method according to claim 15, wherein the acid catalyst is PTSA.

17. A method of preparing unsaturated hydroxy fatty acids and esters thereof corresponding to general formula (Id): 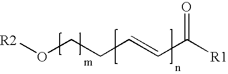
wherein n=1 to 4, m=2 to 16,
R₁═OH, Cl, Br, OR₃ in which R₃ is a straight or branched alkyl, alkenyl or alkynyl radical of 1 to 16 carbons or glycerol esters, optionally substituted by one or more atoms selected from the group consisting of carbon, nitrogen, sulfur and halogens,
R₂═H, SiR′₁R′₂R′₃ in which R′₁, R′₂ and R′₃ can be identical or different from each other and are a straight or branched alkyl, alkenyl or alkynyl radical of 1 to 16 carbons or glycerol esters, optionally substituted by one or more atoms selected from the group consisting of carbon, nitrogen, sulfur and halogens,
or R₂═C—Ar₃ with Ar representing an aryl radical optionally substituted by one or more atoms selected from the group consisting of carbon, nitrogen, sulfur and halogens,
or R₂=the tetrahydropyranyl of formula: 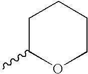
comprising:
a) brominating an initial diol of formula II: 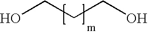
in an aqueous or nonaqueous solvent;
b) oxidizing a bromide formed in step (a) in the presence of an optionally cyclic, optionally anhydrous tertiary amine N-oxide in the presence of DMSO to form an aldehyde of formula IV;
c) subjecting the aldehyde formed in step (b) to a Wittig-Homer reaction;
d) subjecting the product of step (c) to saponification to form a compound of general formula Ib: 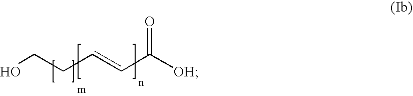
and
e) subjecting the compound of general formula (Ib) obtained in step (d) to a specific protection of an alcohol functional group in the presence of an acid catalyst.

18. The method according to claim 17, wherein the solvent is selected from the group consisting of toluene, benzene, dimethylformamide, tetrahydrofuran, cyclohexane, heptane and petroleum ether.

19. The method according to claim 17, wherein a reagent used in step (a) is selected from the group consisting of aqueous or nonaqueous HBr, Ph₃P,Br₂, carbon triphenylphosphine tetrabromide and hydrobromic acid.

20. The method according to claim 17, wherein step (b) is an oxidation of an aldehyde of formula (IV) in the presence of an optionally cyclic, optionally anhydrous tertiary amine N-oxide and in the presence of DMSO.

21. The method according to claim 17, wherein the Wittig-Homer reaction is carried out in the presence of triethylphosphonoacetate and potassium carbonate.

22. The method according to claim 17, wherein step (e) is carried out with dihydropyrane in the presence of PTSA (para-toluene sulfonic acid).

23. The method according to claim 17, wherein a product of formula (Id) obtained in step (e) is subjected to a final deprotection to obtain the compound of general formula (Ie).

24. The method according to claim 17, wherein a product of formula (Id) obtained in step (e) is used in an esterification reaction of the glycerol prior to undergoing final deprotection.

25. A method of preventing or treating degradation of collagen comprising administering a therapeutically effective amount of a compound formed according to the method of claim 17 to a patient in need.

26. A method of preventing or treating degradation of collagen by bacterial collagenases during a bacterial infection comprising administering a therapeutically effective amount of a compound formed according to claim 17 to a patient in need.

27. A method of regenerating skin and ligaments comprising administering a therapeutically effective amount of a compound produced according to claim 17 to a patient in need.

28. A method of preventing or treating tumoral invasion comprising administering a therapeutically effective amount of a compound produced according to claim 17 to a patient in need.

29. A method of preventing or treating degenerative diseases having fibrinoid degeneration of collagen comprising administering a therapeutically effective amount of a compound produced according to claim 17 to a patient in need.

30. A method of reducing weight in a patient in need thereof comprising administering a therapeutically effective amount of a compound made according to the method of claim 17.
